(19) United States
(12) Patent Application Publication
(10) Pub. No.: US 2002/0147981 A1
(43) Pub. Date: Oct. 10, 2002

(54) Commodity rental system and method

(75) Inventors: Akimasa Ohta, Tokyo (JP); Yoshihiro Inomata, Tokyo (JP)

Correspondence Address: SUGHRUE MION, PLLC, 2100 Pennsylvania Avenue, N.W., Washington, DC, 20037-3213, US

(73) Assignee: NEC CORPORATION

(21) Appl. No.: 10/113,559

(22) Filed: Apr. 2, 2002

(30) Foreign Application Priority Data
Apr. 4, 2001 (JP) 2001-105496JP

(51) Int. Cl. H04N 7/16; H04N 7/173

(52) U.S. Cl. 725/93; 725/91; 725/25

(57) ABSTRACT

A commodity rental system is provided in which a box for storing rental commodities, central management means for managing a locking and an unlocking operations of said box in a lump, and a user's communication terminal were connected via a network, said commodity rental system being characterized in that: a reservation receipt process of the corresponding rental commodity is performed responding to a reservation request of the rental commodity from said user's terminal; an installation location and a box number of the box in which the above rental commodity was stored is notified to said user's terminal; and the locking and the unlocking operations of said box is controlled in a lump by a locking and an unlocking requests of the box from said user's terminal.

### BACKGROUND OF THE INVENTION

The present invention relates to a commodity rental system and method, and more particularly to a commodity rental system and method in which, by managing a locking and an unlocking operations of a box for storing rental commodities in a lump via a network, commodities can be rented at an unmanned shop, and a settlement of a bill can be simplified.

Conventionally, for example, in the event of utilizing a rental service, generally, a user goes to a rental video shop, looks for a video that the he/she desires to rent among from exhibited videos, and follows the procedure for renting. In the event of returning the video, the user makes it a rule to go to the rental video shop to follow the procedure for returning the rented video. On the other hand, a video rental vendor manages personal information and lending information of each user by means of a terminal device, and lends the video to him/her.

In the conventional rental system, however, the following problems existed. Firstly, since the user was not able to confirm the inventory of the video that he/she desired to rent until he/she went to the rental video shop, there was the case that he/she was not able to rent it when the video that he/she desired to rent was already lent. Also, since the operation hour of the rental video shop was limited, needless to say, it was impossible to rent or return the video for the non-operation hour. This was very inconvenient for the user.

### SUMMARY OF THE INVENTION

The present invention has been accomplished so as to settle the above-mentioned problems, and an objectivity thereof is to provide a commodity rental system and method in which, by managing a locking and an unlocking operations of a box for storing rental commodities in a lump via a network, commodities can be lent at an unmanned shop, and a settlement of a bill can be simplified.

So as to accomplish these problems, the commodity rental system of the present invention, which is a commodity rental system in which a box for storing rental commodities, central management means for managing a locking and an unlocking operations of said box in a lump, and a user's communication terminal were connected via a network, is characterized in that said central management means comprising a data base for holding information on said rental commodity and a installation location and a box number of the box in which the above commodities were stored, which were registered correspondingly, retrieves said data base in the event that reservation of the rental commodity was received from said user's terminal, performs a reservation receipt process for the corresponding commodity, and notifies said user's terminal the installation location and the box number of the box in which the above rental commodities were stored.

In such a manner, in the commodity rental system of the present invention, the locking and the unlocking operations of the box in which the rental commodities were stored are managed in a lump, and together with it, the user can make reservation for renting the stored commodity. For this end, the user does not bother to go to the rental shop, and can easily confirm the inventory or rent it.

Also, the commodity rental system of the present invention is characterized in that, in the event that a locking and an unlocking requests of the box was received from said user's terminal, said central managing means controls the locking and the unlocking operations of the corresponding box.

In such a manner, in the commodity rental system of the present invention, since the locking and the unlocking operation of the box is adapted to be performed responding to a request by the user, the commodity can be prevented from being stolen by a third party. Thereby, the unmanned rental shop can be materialized, personal expenses and shop operating expenses can be reduced drastically. Also, since the box can operate for 24 hours, the user can return the commodity during the time convenient for him/her.

Also, the commodity rental system of the present invention is characterized in that, in the event that said user took out the rental commodity from said box, said central management means starts a calculation of a time for using the above rental commodity, and together with it, notifies said user's terminal a date for returning the above rental commodity.

Also, the commodity rental system of the present invention is characterized in that, in the event that said user returned the rental commodity to said box, said central management means finishes a calculation of the time for using the above rental commodity, and together with it, notifies said user's terminal a charge for using the above rental commodity.

Also, the commodity rental system of the present invention in which settlement means is further connected to said network is characterized in that, in the event that a settlement request of the charge for using was received from said central management means, the above charge for using is settled from said user.

Since the commodity rental system of the present invention comprises the settlement means connected to the network in such a manner, the user can automatically settle the charge for using the commodity that he/her rented. This enables the user to rent the commodity without cash.

Also, the commodity rental system of the present invention is characterized in that, in the event that a reservation of the rental commodity, which was not present in said database, was received from said user's terminal, the corresponding rental commodity is procured and is stored in said box, and storage of the above rental commodity is notified to said user's terminal.

In such a manner, in the commodity rental system of the present invention, in the event hat a reservation of the commodity, which was not stored in the box, was received, the rental commodity is adapted to be procured, whereby the user can preferredly rent the commodity that he/her desires to do.

Also, in the commodity rental system of the present invention, a reservation of the rental commodity from said user's terminal preferably includes specification of the installation location of the box for storing said rental commodity.

Also, the commodity rental method of the present invention, which is a method of, by managing the locking and the unlocking operations of the box for storing the rental commodities as a package by means of communication terminals via the network, lending the commodities to the user, is characterized in comprising the steps of: offering said user rental commodity information including the rental commodities and an installation location of the box in which the above commodities were stored; in the event that a reservation of the rental commodity was received from said user, notifying said user the installation location and a box number of the box in which the above rental commodity was stored; and responding to an unlocking request of said box from said user, unlocking the above box.

Also, the commodity rental method of the present invention, which is a method of, by managing the locking and the unlocking operations of the box for storing the rental commodities as a package by means of communication terminals via the network, lending the commodity to the user, is characterized in comprising the steps of: offering said user rental commodity information including the rental commodities and the installation location of the box in which the above commodities were stored; in the event that a reservation of the rental commodity, which was not included in said rental commodity information, was received from said user, procuring the above commodity by a rental vendor to store it in said box, and to notify said user the effect that the above commodity was stored; notifying said user the installation location and a box number of the box in which the above rental commodity was stored; and responding to an unlocking request of said box from said user, unlocking the above box.

Also, in the commodity rental method of the present invention, a reservation of the rental commodity from said user preferably includes specification of the installation location of the box for storing said rental commodity.

Also, the commodity rental method of the present invention is characterized in further comprising the steps of: in the event that said user took out the rental commodity from said box, notifying said user a date for returning the above rental commodity together with starting a calculation of a time for using the above rental commodity; and locking the empty box from which said rental commodity was taken out.

Also, the commodity rental method of the present invention is characterized in further comprising the steps of: responding to an unlocking request of said box from said user, unlocking the above box; in the event that said user returned the rental commodity to said box, notifying said user's terminal a charge for using the above rental commodity together with finishing a calculation of a time for using the above rental commodity; and locking the box to which said rental commodity was returned.

Also, the commodity rental method of the present invention is characterized in comprising the step of, in the event that the calculation of said charge for using was finished, settling the charge for using from said user.

### BRIEF DESCRIPTION OF THE DRAWINGS

This and other objects, features and advantages of the present invention will become more apparent from the following detailed description taken in conjunction with the attached drawings, in which:

FIG. 1 is a block diagram illustrating a configuration of the commodity rental system relating to the first embodiment of the present invention;

FIG. 2 is a flowchart for explaining the operation of the commodity rental system relating to the first embodiment of the present invention.;

FIG. 3 is a block diagram illustrating a configuration of the commodity rental system relating to the second embodiment of the present invention and

FIG. 4 is a flowchart for explaining the operation of the commodity rental system relating to the second embodiment of the present invention.

### DESCRIPTION OF THE EMBODIMENTS

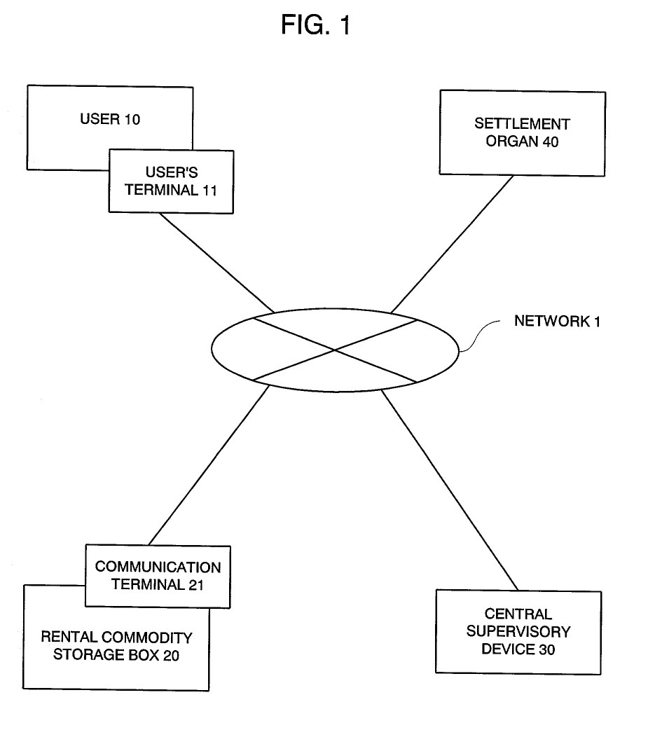

Embodiments of the present invention will be explained below by referring to the accompanied drawings. FIG. 1 is a diagram illustrating a configuration of a commodity rental system relating to a first embodiment of the present invention. As shown in FIG. 1, in the commodity rental system relating to this embodiment, a communication terminal 11 that a user 10 has, a communication terminal 21 that a box 20 for storing the rental commodities comprises, a central supervisory device 30 for taking control for locking and unlocking of the box 20 in a lump, and a settlement organ 40 for settling a rental charge are connected to a network 1.

The user's terminal 11, which is a communication terminal that can make data communication, includes at least an information input section and a display screen (not shown). For example, a personal computer, a mobile information terminal, a mobile telephone, or the like can be employed. This user's terminal 11 displays information to be transmitted from the central supervisory device 30 on the screen, and together with it, has a function of requesting the locking or the unlocking of the box 20 of the central supervisory device 30.

The box 20, which consists of a plurality of boxes for storing the rental commodities, is a box installed in public and convenient locations that operates for 24 hours. A locker system, which is available conventionally, can be preferredly employed as this box. Additionally, this box has a function of, upon confirming that the user 20 took out the rental commodity, automatically notifying the central supervisory device 30 taking-out of the commodity. For example, a sensor and so forth are provided at the area in which the rental commodity is stored so that the taking-out is recognized at the moment that the rental commodity was pulled out.

Also, the box 20 comprises the communication terminal 21 that can make data communication. A packet communication terminal, a personal computer, a mobile terminal, or the like can be employed as the communication terminal 21, which takes control of the locking and the unlocking operations of the rental commodity storage box 20 based on a control signal from the central supervisory device 30. Additionally, the communication terminal 21 may be directly connected to the network 1 by a wire, but also may be connected to the network 1 via radio communication that is made between mobile telephone vendors or between exclusive radio bases (not shown).

The central supervisory device 30 comprises an inventory database (not shown) that accumulated information on the rental commodities stored in the box 20. In this inventory database, are held a name of the commodity that can be rent (ID etc.), a rental charge according to a rental period, an extra-period rental charge in the event that the due period elapsed, information associated with the installation location and the box number of the box in which the rental commodities were stored, and so forth. Also the central supervisory device 30 retrieves the rental commodity specified by the user 10 from the inventory database, and notifies the user's terminal 11 the installation location and box number of the box in which the corresponding rental commodity was stored via the network 1. Further, the central supervisory device 30 transmits a control signal to the communication terminal 21, which the box 20 comprises, responding to the locking and the unlocking requests of the box from the user's terminal 11. Also, the central supervisory device 30 calculates a rental charge pre-decided responding to the time for using the rental commodity, and transmits information on the charge for using to the user's terminal 11 and the settlement organ 40 via the network 1.

The settlement organ 40 receives information on the charge for using transmitted from the central supervisory device 30, and makes it a rule to withdraw the charge for using by automatic fund transfer from a bank account of the user 10 connected to the network. Next, it performs a process for transferring the charge for using collected from the user to an operating company that lends the rental commodities. Accordingly, in receiving a service in accordance with this rental system, the user 10 preferably registers a procedure for withdrawal from the account, a credit card number, and so forth to the central supervisory device 30. Additionally, the central supervisory device 30 may serve concurrently as this settlement organ 40.

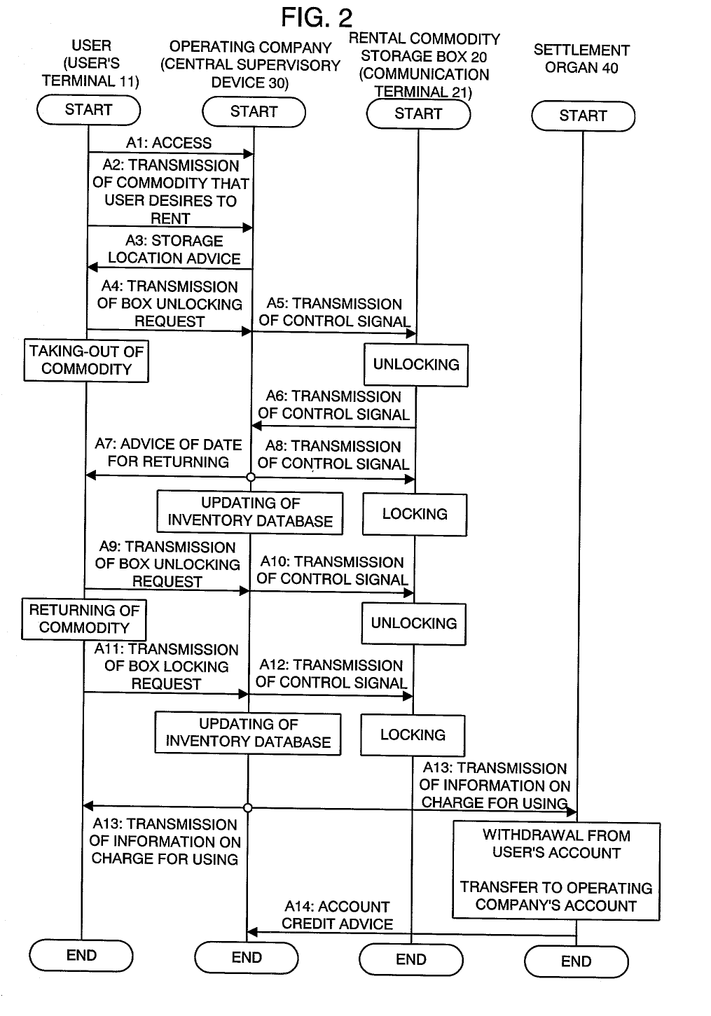

Next, an operation of a first embodiment of the present invention will be explained below by referring to FIG. 1 and FIG. 2. FIG. 2 is a flowchart for explaining the operation of the commodity rental system relating to the first embodiment of the present invention. At first, the user 10 makes access to a commodity rental site that the central supervisory device 30 offers over the network 1 via the user's terminal 11 (step A1). On this commodity rental site are offered a list of various rental commodities, the rental charges thereof, and so forth, and the user 10 can select the rental commodity that he/her desires to rent from among them. When the user 10 selects the rental commodity that he/her desires to rent (step A2), the central supervisory device 30 retrieves the inventory database based on information on the rental commodity that he/her desires to rent, and performs a reservation receipt process for the above commodity. Additionally, similarly to the conventional rental system, when the user utilizes this rental system, he/she is required to register in advance information, which can certify an address, a name and a status of the user, and further an address, a password, and so forth which can identify the user's terminal 11.

Next, the central supervisory device 30 transmits to the user's terminal 11 a reservation completion advice including the installation location and the box number of the rental commodity storage box 20 in which the commodity that the user desired to rent was stored (step A3). In addition, it is preferable that the process is adapted so that, in this reservation receipt process, the installation location of the box 20, in which the commodity that the user 10 desired to rent was stored, can be selected. Also, it is preferable that the process is adapted so that the user 10 can retrieve the commodity that he/her desires to rent from the box installation location from which he/her desires to rent.

Next, the user 10 goes to the installation location of the corresponding rental commodity storage box 20 based on information from the central supervisory device 30, and transmits the unlocking request of the corresponding box 20 to the central supervisory device 30 via the user's terminal 11 (step A4). The central supervisory device 30 receives the unlocking request transmitted from the terminal 11 of the user 10, and transmits the control signal to the communication terminal 21 provided in the rental commodity storage box 20 (step A5). The communication terminal 21 unlocks a key of the corresponding box 20 based on the received control signal, and the user 10 takes out the rental commodity from the rental commodity storage box 20. Additionally, for prevention of crimes, in order that the commodity can be surely rented by a true user, this box is preferably unlocked after passing through a procedure such as a password authentication pre-established between the central supervisory device 30 and the user 10.

When the rental commodity storage box 20 recognizes that the user 10 took out the rental commodity, it transmits the control signal to the central supervisory device 30 via the communication terminal 21 (step A6). When the central supervisory device 30 receives the control signal, it updates the inventory database that the central supervisory device 30 has, and together with it, notifies the user's terminal 11 a date for returning (step A7). This updating of the inventory database includes the fact that the rental commodity has already been lent, and a record of information on a rental starting time and so forth. The central supervisory device 30 simultaneously transmits the control signal for locking the corresponding box 20 to the communication terminal 21 of the rental commodity storage box 20 (step A8), and the communication terminal 21 that received this control signal locks the corresponding box 20. Additionally, herein, the locking of the box 20 after taking-out of the commodity may be conducted by transmitting to the central supervisory device 30 the effect that the user 10 took out the commodity.

Next, in the event that the user 10 returns the rental commodity, the user 10 transmits the unlocking request of the box 20 to the central supervisory device 30 in front of the box 20 to which he/her returns the commodity via the terminal 11 (step A9). The central supervisory device 30 receives the unlocking request, and transmits the control signal for unlocking to the terminal 21 of the rental commodity storage box 20 (step A10). The communication terminal 21 receives the control signal from the central supervisory device 30, and unlocks the corresponding box 20. The user 10 returns the rental commodity to the unlocked rental commodity storage box 20, and simultaneously transmits the locking request of the box 20 via his/her own terminal 11 to the central supervisory device 30 (step A11).

The central supervisory device 30 receives the locking request from the user's terminal 11, and transmits the control signal for locking the corresponding box 20 to the communication terminal 21 of the rental commodity storage box 20 (step A12). The communication terminal 21 that received this control signal locks the key of the corresponding box 20. Also, the central supervisory device 30 updates the inventory database regarding the rental commodity of which the return was completed. This updating includes the fact that the above rental commodity came back to the situation that it can be lent and a record of information on a rental finish time and so forth. Additionally, similarly to the moment of lending, unlocking the box at the moment of returning is preferably conducted after passing through a process such as the password authentication.

Next, the central supervisory device 30 calculates the charge for using from the rental time for using to transmits information on the charge for using to the user's terminal 11, together with it, transmits information on the charge for using to the settlement organ 40, and requests the automatic fund transfer from the bank account of the user 10 (or the settlement by a credit card) of the settlement organ 40 (step A13). The settlement organ 40 withdraws the charge for using from the account of the user 10 based on information on the received charge for using. Then, it transfers the collected charge for using to the bank account of the operating company of the central supervisory device 30, and transmits an account credit advice to the central supervisory device 30 (step A14). Additionally, as to the rental period for using the commodity, for example, it is pre-decided for each rental commodity, and in the event that its period elapsed, extra-period charge should be collected.

As explained above, in accordance with the commodity rental system of this embodiment, the user and the rental commodity supplier make the data communication, whereby the user does not need to go to the rental shop to confirm the inventory. Also, the locking and the unlocking operations of the box for storing the rental commodities are managed in a lump by the central supervisory device, that is, the box is adapted to be locked at the other moment than the moment of lending and returning the rental commodity, whereby the commodity can be prevented from being stolen, and together with it, the unmanned rental shop can be realized. And, further, the settlement organ is connected via the network, whereby the user can make an automatic settlement of the rental charge, and a non-cash transaction can be realized.

Herein, in accordance with the commodity rental system of the present invention, the user and the time for using can be managed as a package with the inventory database, whereby various charging forms can be applied. For example, in addition to a method of issuing a bill every one-time utilizing, the charge for using is summed up during a constant period (e.g. once a month) and the bill may be issued every constant period. Also, in addition to charging proportional to the time for using, discount for the user that utilizes frequently can be made.

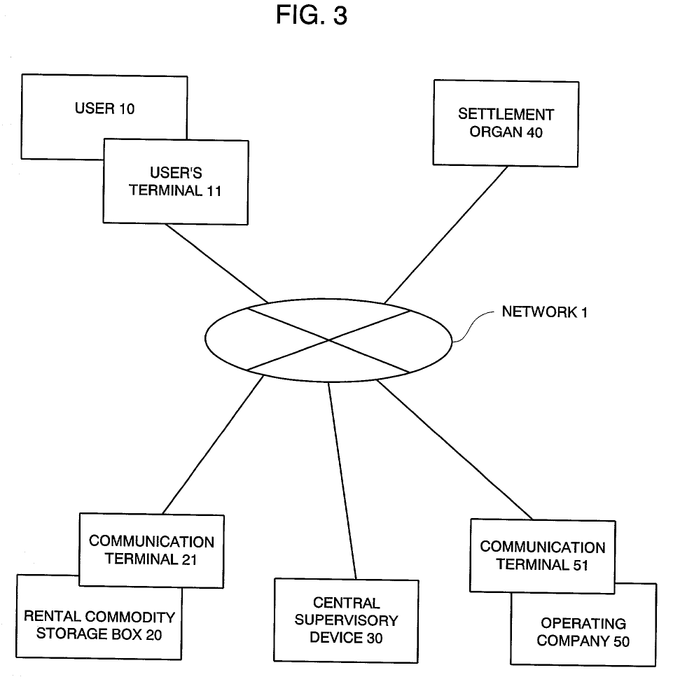

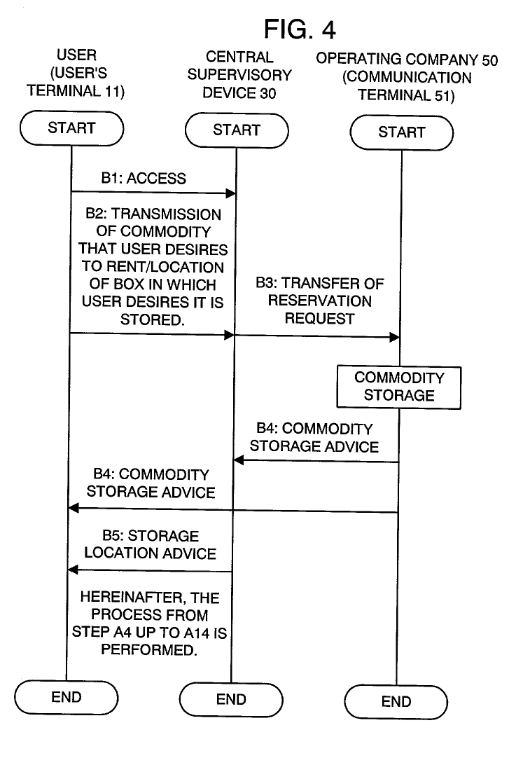

Next, the commodity rental system relating to a second embodiment of the present invention will be explained. In the first embodiment described above, the case was explained that the commodity that the user desired to rent was already stored, but in this embodiment, the case will be explained that the commodity that the user desired to rent was not stored. FIG. 3 is a diagram illustrating a configuration of the commodity rental system relating this embodiment, and FIG. 4 is a flowchart for explaining an operation of the commodity rental system relating this embodiment.

As shown in FIG. 3, in the commodity rental system relating this embodiment, in addition to the configuration of the first embodiment, a communication terminal 51 of a rental commodity operating company 50 was connected to the network 1. This communication terminal 51 is an information terminal that can make mutual data communication with the central supervisory device 30 and the user's terminal 11 respectively. Additionally, the central supervisory device 30 can serve concurrently as the communication terminal 51 of this operating company 50. In this embodiment, since the other than the configuration of the operating company 50 is the same as that of the first embodiment, the same codes are to be appended, and the explanation for duplicating herein is to be omitted.

Next, the operation of the commodity rental system relating to this embodiment will be explained by referring to FIG. 3 and FIG. 4. At first, the user 10 makes access to a commodity rental site that the central supervisory device 30 offers via the user's terminal 11 (step B1). Herein, in the event that the rental commodity that the user 10 desires to rent is not present in the commodity list of the inventory database, he/her transmits to the central supervisory device 30 a predetermined reservation request including the commodity that he/her desires to rent and the location of the box in which he/her desires it is stored (step B2).

Then, responding to the reservation request from the user 10, the central supervisory device 30 transmits the contents of the above reservation request to the communication terminal 51 of the operating company 50. The operating company 50, which received this reservation request, procures the corresponding rental commodity, and stores the rental commodity in the corresponding storage box 10. When this storage is completed, the operating company 50 transmits to the user's terminal 11 via the communication terminal 51 an advice of the effect that the commodity that the user desired to rent was stored (step B3). The operating company 50 simultaneously transmits a commodity storage advice to the central supervisory device 30 as well, and the inventory database is updated in the central supervisory device 30. Additionally, in this embodiment, at the moment that this storage completion advice was transmitted to the central supervisory device 30, the reservation by the user 10 is to be completed. On the other hand, for confirmation, is transmitted to the user 10 via the user's terminal 11 the reservation completion advice including the installation location and the box number of the rental commodity storage box 20 in which the commodity that the user desired to rent was stored (step B4).

The user 10 who received the reservation completion advice from the central supervisory device 30 goes in front of the corresponding box 10, and performs the similar process to that of the first embodiment. Since the operation subsequent to this is similar to that of the first embodiment, the explanation for duplicating herein will be omitted. That is, hereinafter, the operation of the steps A4 to A14 in FIG. 2 is performed.

In this embodiment, the case was explained that the commodity that the user desired to rent was not stored in the box; however the similar method can be applied for the other case as well. For example, this is the case that, even though the commodity that the user desired to rent was stored in the box, the installation location of the box is far away from the location from which the user desires to rent. Also in this case, similarly to that of this embodiment, the operating company 50 procures the rental commodity that the user desires to rent, and stores the rental commodity in the box installed in the location in which the user desires it is stored. The process subsequent to it is similar to the above-mentioned one.

As explained above, in accordance with the commodity rental system of this embodiment, in addition to the effect of the first embodiment, the commodity that gratifies the user's wishes can preferredly be lent, even though it is a commodity that is not included in the inventory database.

Additionally, the commodity rental system of the present invention is not limited to the above-mentioned embodiments, and various alterations to and variations of theses embodiments can be conceived. In the foregoing embodiments, the user 10 is required to take the terminal 11 in front of the box 20; however, for example, the box 10 is configured to comprise an input unit such as a keyboard and a touch panel. Such a configuration allows the commodity to be rented by the user 10 inputting a password and so forth from its unit. Also, as to the rental commodity, the present invention can be applied for anything that can be actually handled as the rental commodity in addition to a video and a book. Additionally, in the central supervisory unit 30, the communication terminal 21, and so forth of the above-mentioned embodiments, all processes are performed by a program control stored in the storage region thereof.

As described above, in accordance with the commodity rental system of these embodiments, the user and the rental commodity supplier make data communication, whereby the user is not required to go to the rental shop to confirm the inventory. Also, the locking and unlocking operations of the box for storing the rental commodities are managed in a lump by the central supervisory device, that is, the box is adapted to be locked at the other moment than the moment of lending and returning the rental commodity, whereby the rental commodity can be prevented from being stolen, and together with it, the unmanned rental shop can be realized. Also, further, the settlement organ is connected via the network, whereby the user can make the automatic settlement of the rental charge, and the non-cash transaction can be realized.

What is claimed is:

1 A commodity rental system in which a box for storing rental commodities, central management means for managing a lock and an unlocking operations of said box in a lump, and a user's communication terminal were connected via a network, characterized in that:
said central management means comprising a data base for holding information on said rental commodities and a installation location and a box number of the box in which the above commodities were stored, which were registered correspondingly, retrieves said data base in the event that reservation of the rental commodity was received from said user's terminal, performs a reservation receipt process for the corresponding rental commodity, and notifies said user's terminal the installation location and the box number of the box in which the above rental commodity was stored.

2. The commodity rental system according to claim 1, characterized in that, in the event that a locking and an unlocking requests of the box was received from said user's terminal, said central management means controls the locking and the unlocking operations of the corresponding box.

3 The commodity rental system according to claim 2, characterized in that, in the event that said user took out the rental commodity from said box, said central management means starts a calculation of a time for using the above rental commodity, and simultaneously notifies said user's terminal a date for returning the above rental commodity.

4 The commodity rental system according to claim 3, characterized in that, in the event that said user returned the rental commodity to said box, said central management means finishes a calculation of the time for using the above rental commodity, and simultaneously notifies said user's terminal a charge for using the above rental commodity.

5 The commodity rental system according to claim 4 characterized in that settlement means, which is further connected to said network, settles the above charge for using from said user in the event that a settlement request of the charge for using was received from said central management means.

6 The commodity rental system according to claim 1, characterized in that, in the event that a reservation of the rental commodity, which was not present in said data base, was received from said user's terminal, the corresponding rental commodity is procured and is stored in said box, and storage of the above rental commodity is notified to said user's terminal.

7 The commodity rental system according to claim 6, characterized in that a reservation of the rental commodity from said user's terminal includes specification of the installation location of the box for storing said rental commodity.

8 A method of, by managing a locking and an unlocking operations of a box for storing rental commodities as a package by mans of communication terminals via a network, lending a commodity to a user, comprising the steps of:
offering said user rental commodity information including the rental commodities and an installation location of the box in which the above commodities were stored;
in the event that a reservation of the rental commodity was received from said user, notifying said user the installation location and a box number of the box in which the above rental commodity was stored; and responding to an unlocking request of said box from said user, unlocking the above box.

9 In the commodity rental system according to claim 8, the commodity rental method, the above method, characterized in further comprising the steps of:
in the event that said user took out the rental commodity from said box, notifying said user a date for returning the above rental commodity together with starting a calculation of a time for using the above rental commodity; and
locking the empty box from which said rental commodity was taken out.

10 The commodity rental method according to claim 9, the above method, characterized in further comprising the steps of:
responding to an unlocking request of said box from said user, unlocking the above box;
in the event that said user returned the rental commodity to said box, notifying said user's terminal a charge for using the above rental commodity together with finishing a calculation of a time for using the above rental commodity,; and
locking the box to which said rental commodity was returned.

11 The commodity rental method according to claim 10, characterized in comprising the step of, in the event that the calculation of said charge for using was finished, settling the charge for using from said user.

12 A method of, by managing a locking and an unlocking operations of a box for storing rental commodities as a package by means of communication terminals via a network, lending a commodity to a user, comprising the steps of:
offering said user rental commodity information including the rental commodities and an installation location of the box in which the above commodities were stored;
in the event that a reservation of the rental commodity, which was not included in said rental commodity information, was received from said user, procuring the above commodity by a rental vendor to store it in said box, and to notify said user the effect that the above commodity was stored;
notifying said user the installation location and a box number of the box in which the said rental commodity was stored; and
responding to an unlocking request of said box from said user, unlocking the above box.

13 The commodity rental method according to claim 12, characterized in that a reservation of the rental commodity from said user includes specification of the installation location of the box for storing said rental commodity.

14 In the commodity rental system according to anyone of claim 12, the commodity rental method, the above method, characterized in further comprising the steps of:
in the event that said user took out the rental commodity from said box, notifying said user a date for returning the above rental commodity together with starting a calculation of a time for using the above rental commodity; and
locking the empty box from which said rental commodity was taken out.

15 The commodity rental method according to claim 14, the above method, characterized in further comprising the steps of:
responding to an unlocking request of said box from said user, unlocking the above box;
in the event that said user returned the rental commodity to said box, notifying said user's terminal a charge for using the above rental commodity together with finishing a calculation of a time for using the above rental commodity,; and
locking the box to which said rental commodity was returned.

16 The commodity rental method according to claim 15, characterized in comprising the step of, in the event that the calculation of said charge for using was finished, settling the charge for using from said user.
